(19) United States
(12) Patent Application Publication
(10) Pub. No.: US 2015/0028774 A1
(43) Pub. Date: Jan. 29, 2015

(54) LIGHT-EMITTING ELEMENT LIGHTING DEVICE, LIGHT-EMITTING MODULE, ILLUMINATING APPARATUS, AND LIGHT-EMITTING ELEMENT LIGHTING METHOD

(71) Applicant: Panasonic Corporation, Osaka (JP)

(72) Inventors: Hirofumi KONISHI, Osaka (JP); Masanao OKAWA, Nara (JP); Yohei HAYASHI, Osaka (JP); Itaru ONISHI, Osaka (JP)

(21) Appl. No.: 14/338,510

(22) Filed: Jul. 23, 2014

(30) Foreign Application Priority Data
Jul. 26, 2013 (JP) 2013-156042

(51) Int. Cl. H05B 33/08

(52) U.S. Cl. CPC H05B 33/0884
USPC 315/302

(57) ABSTRACT

A light-emitting element lighting device includes: a step-down chopper circuit which outputs current to a light-emitting element; a current command circuit which selects between (i) light-emission mode for causing a light-emission current larger than a constant rated current, which flows to the light-emitting element when continuous light-emission is caused, to flow and (ii) detection mode for causing an abnormality detection current smaller than the rated current, to flow for detecting a light-emitting element abnormality; a voltage detection circuit which detects a both-end voltage of the light-emitting element; and a control circuit which causes the step-down chopper circuit to stop outputting the current to the light-emitting element, when the both-end voltage detected by the voltage detection unit in the detection mode is lower than or equal to an abnormality detection threshold voltage which is set lower than the rated voltage at a time when the light-emitting element is turned ON.

### CROSS REFERENCE TO RELATED APPLICATION

This application claims the benefit of priority of Japanese Patent Application Number 2013-156042, filed Jul. 26, 2013, the entire content of which is hereby incorporated by reference.

### TECHNICAL FIELD

The disclosure relates to: a lighting device which turns on a light-emitting element such as a light-emitting diode (LED); a light-emitting module; an illuminating apparatus including the lighting device and the light-emitting module; and a light-emitting element lighting method.

### BACKGROUND ART

Recent years have seen the growing popularity of illuminating apparatuses using light-emitting modules including light-emitting elements such as light-emitting diodes (LED) as substitutes for incandescent lamps.

Patent Literature (PTL) 1 (Japanese Unexamined Patent Application Publication No. 2007-536708) discloses an illuminating apparatus to which plural flat panel light sources are electrically connected.

FIG. 14 is an outline configuration diagram of a conventional light-emitting unit apparatus disclosed in PTL 1. The figure illustrates a light-emitting unit apparatus which includes: plural light-emitting units 905; and communication lines connected to the light-emitting units 905, for communicating control signals. The respective light-emitting units 905 have plural electrical contacts for the supply of power and, by being electrically connected to each other, are able to supply power to adjacent light-emitting units 905. Furthermore, PTL 1 discloses that each light-emitting unit 905 includes a control device and, through signal communication between adjacent control devices, plural light-emitting units 905 can operate in conjunction with one other. Furthermore, each light-emitting unit 905 is controlled so that a constant current flows to the light-emitting element in order to produce a constant luminance.

### SUMMARY

Since individual light-emitting modules, including the light-emitting units in PTL 1, typically produce a constant luminance, a configuration which detects a light-emitting element having a short-circuit abnormality (also referred to here as a short-circuited abnormal (light-emitting) element) is adopted.

In particular, among light-emitting elements, organic electroluminescence (EL) light-emitting elements are configured of organic EL thin-film material having a thickness ranging from tens of nanometers to hundreds of nanometers, and thus the presence of foreign matter and impurities in materials, and so on, during manufacturing significantly affects the operating life of a module. A short-circuit fault in an organic EL light-emitting element occurs due to the presence of conductive foreign matter in a light-emitting layer between a positive electrode and a negative electrode. Therefore, when the voltage obtained when a rated current flows through an organic EL light-emitting element is lower than a threshold voltage, it can be concluded that current is accumulating in the conductive foreign matter, and thus it can be judged that a short-circuit abnormality has occurred in the element.

Here, in order to avoid normal components from being erroneously detected, consideration is given to temperature characteristics-induced variation from the rated voltage that is supposed to be generated when the rated current flows, and the aforementioned threshold voltage is typically set with a predetermined margin from the rated voltage. On the other hand, there are various states of short-circuit abnormality such as full conductivity and unstable conductivity due to point contact, and there is a large variation in the voltage generated when the rated current flows. With this, there is the problem that, even when the rated current flows, a short-circuited abnormal element cannot be accurately detected using the set threshold voltage.

The present invention is conceived in view of the aforementioned problem and has as an object to provide a light-emitting element lighting device, a light-emitting module, an illuminating apparatus, and a light-emitting element lighting method which accurately detect a short-circuit abnormality in an organic EL light-emitting element which is turned ON with a rated current, and take appropriate measures.

In order to achieve the aforementioned object, a light-emitting element lighting device according to an aspect of the present invention is a light-emitting element lighting device which turns ON a light-emitting element, the light-emitting element lighting device including: a current generation unit configured to output a current that flows to the light-emitting element; a mode selection unit configured to select between (i) a light-emission mode for causing a light-emission current, which is larger than a rated current, to flow and (ii) a detection mode for causing an abnormality detection current, which is smaller than the rated current, to flow for detecting an abnormality in the light-emitting element, the rated current being a constant current that is caused to flow to the light-emitting element when the light-emitting element is caused to emit light continuously; a voltage detection unit configured to detect a both-end voltage of the light-emitting element; and a current control unit configured to cause the current generation unit to stop outputting the current to the light-emitting element, when the both-end voltage detected by the voltage detection unit in the detection mode is lower than or equal to an abnormality detection threshold voltage which is set lower than the rated voltage at a time when the light-emitting element is turned ON.

Furthermore, in a light-emitting element lighting device according to another aspect of the present invention, an average current in a predetermined lighting period in which the light-emission current and the abnormality detection current flow may be equal to the rated current.

Furthermore, in a light-emitting element lighting device according to another aspect of the present invention, the abnormality detection threshold voltage may be set lower than or equal to a light emission start voltage at which the light-emitting element starts to emit light.

Furthermore, in a light-emitting element lighting device according to another aspect of the present invention, the mode selection unit may be configured to select the light-emission mode and the detection mode alternately.

Furthermore, in a light-emitting element lighting device according to another aspect of the present invention, the mode selection unit may be further configured to, when a dimming signal is inputted from an outside source, determine, based on the dimming signal, a ratio between a period in which a current flows to the light-emitting element and a period in which a current does not flow to the light-emitting element.

Furthermore, in a light-emitting element lighting device according to another aspect of the present invention, a period in which the abnormality detection current flows and a period in which the light-emission current flows may be set in this sequence in the period in which a current flows to the light-emitting element.

Furthermore, in a light-emitting element lighting device according to another aspect of the present invention, the current control unit may be configured to cause the current generation unit to stop outputting a current to a light-emitting module that includes the light-emitting element singularly or in a plurality connected in series, when, in the detection mode which is set in a transient period, a both-end voltage of the light-emitting module detected at a predetermined time in the transient period is lower than or equal to the abnormality detection threshold voltage that is set lower than a sum light-emission voltage which is a sum of light-emission voltages at a time when light-emitting elements included in the light-emitting module are turned ON, the transient period being a period in which a current which is smaller than the rated current transitions to the light-emission current which is larger than the rated current.

Furthermore, in a light-emitting element lighting device according to another aspect of the present invention, the mode selection unit may be configured to select the detection mode at least once in a period in which the light-emitting module is continuously turned ON.

Furthermore, in a light-emitting element lighting device according to another aspect of the present invention, the mode selection unit may be configured to select the detection period for a predetermined period, immediately after power supply is provided.

Furthermore, in a light-emitting element lighting device according to another aspect of the present invention, the current control unit may be configured to shorten a period from a start time of the transient period up to the predetermined time, as the number of the light-emitting elements included in the light-emitting module is increased.

Furthermore, in a light-emitting element lighting device according to another aspect of the present invention, the current control unit may be configured to set the abnormality detection threshold voltage higher as the number of the light-emitting elements included in the light-emitting module is increased.

Furthermore, a light-emitting module according to an aspect of the present invention includes: a light-emitting element; and any of the above-described light-emitting element lighting devices.

Furthermore, an illuminating apparatus according to an aspect of the present invention includes a plurality of the above-described light-emitting modules.

Furthermore, the present invention can be implemented not only as a light-emitting element lighting device, light-emitting module, and illuminating apparatus which include such characteristic components, but also as a lighting method for turning ON a light-emitting element.

According to the light-emitting element lighting device according to an aspect of the present invention, the current control unit judges short-circuit abnormality according to whether or not the voltage of the light-emitting element, which is detected when the abnormality detection current which is lower than the rated current flows, is lower than or equal to the abnormality detection threshold voltage which is set lower than the rated voltage. Therefore, compared to the case where short-circuit abnormality is judged according to the voltage of the light-emitting element detected when the rated current flows, it is possible to clearly distinguish between the voltage of a normal light-emitting element and the voltage of a short-circuited abnormal light-emitting element, and thus a short-circuit abnormality can be detected with high accuracy. Furthermore, current output to a short-circuited abnormal element can be reliably stopped.

### BRIEF DESCRIPTION OF THE DRAWINGS

The figures depict one or more implementations in accordance with the present teaching, by way of examples only, not by way of limitations. In the figures, like reference numerals refer to the same or similar elements.

FIG. 1 is a block configuration diagram of a light-emitting element lighting system according to Embodiment 1.

FIG. 2 is a diagram illustrating an example of a circuit configuration of a light-emitting element lighting system according to Embodiment 1.

FIG. 3 is a timing chart for describing the operation of a control circuit according to Embodiment 1.

FIG. 4 is an operation flowchart for describing a light-emitting element lighting method according to Embodiment 1.

FIG. 5 is a timing chart for light-emission current and abnormality detection current according to Embodiment 1.

FIG. 6 is a graph illustrating voltage-current characteristics of a normal and short-circuited abnormal light-emitting element.

FIG. 7 is a timing chart for light-emission current and abnormality detection current according to Embodiment 2.

FIG. 8 is a timing chart for light-emission current and light-emission voltage according to Embodiment 3.

FIG. 9 is a timing chart for light-emission current and light-emission voltage when an abnormality detection method according to Embodiment 3 is used while a light-emitting element is turned ON.

FIG. 10 is a graph illustrating a relationship between the number of serially connected light-emitting elements in a light-emitting module and detection time.

FIG. 11 is a graph illustrating a relationship between the number of serially connected light-emitting elements in a light-emitting module and abnormality detection threshold voltage.

FIG. 12 is a block configuration diagram of an illuminating system including a light-emitting module according to Embodiment 4.

FIG. 13 is an outline perspective view of an illuminating apparatus according to Embodiment 5.

FIG. 14 is an outline configuration diagram of a conventional light-emitting unit apparatus disclosed in PTL 1.

### DETAILED DESCRIPTION

Hereinafter, light-emitting element lighting devices, light-emitting modules, illuminating apparatuses, and light-emitting element lighting methods according to exemplary embodiments of the present invention will be described with reference to the drawings. It should be noted that each of the subsequently-described embodiments show a specific preferred example of the present invention. Therefore, numerical values, shapes, materials, structural components, the arrangement and connection of the structural components, etc. shown in the following exemplary embodiments are mere examples, and are not intended to limit the scope of the present invention. Furthermore, among the structural components in the following exemplary embodiment, components not recited in any one of the independent claims which indicate the broadest concepts of the present invention are described as arbitrary structural components.

### Embodiment 1

Hereinafter, a light-emitting element lighting device according to Embodiment 1 will be described with reference to the Drawings.

(Configuration)

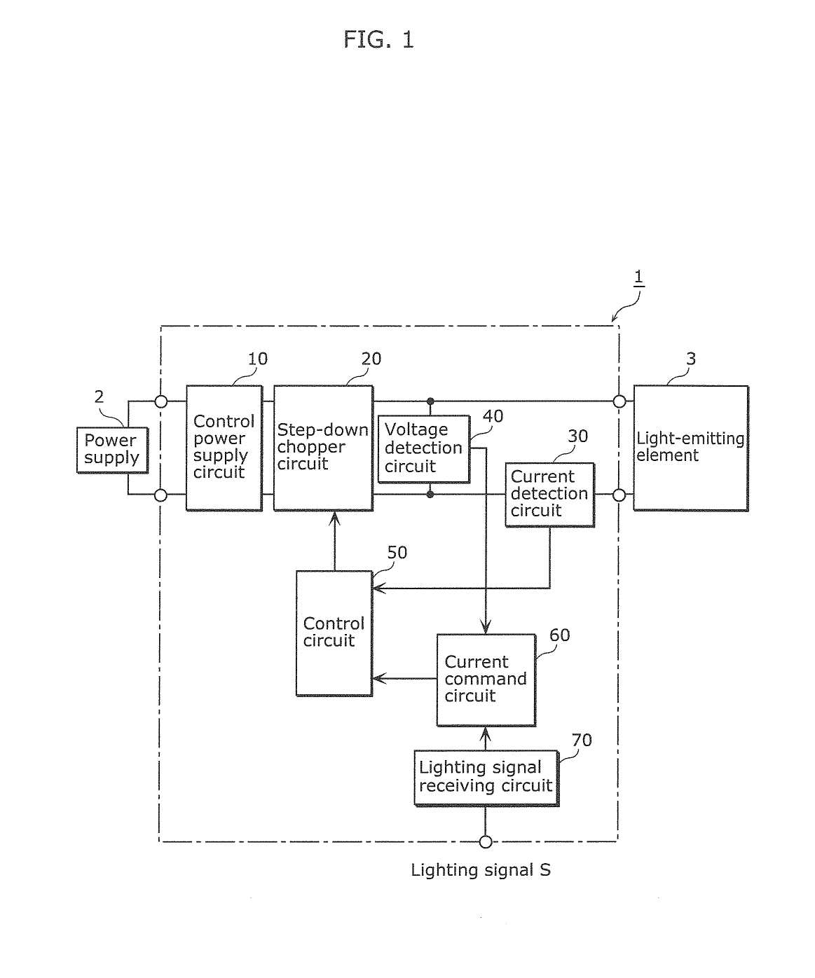

FIG. 1 is a block configuration diagram of a light-emitting element lighting system according to Embodiment 1. The light-emitting element lighting system illustrated in the figure includes a light-emitting element lighting device 1, a power supply 2, and a light-emitting element 3. Furthermore, the light-emitting element lighting device 1 includes a control power supply circuit 10, a step-down chopper circuit 20, a current detection circuit 30, a voltage detection circuit 40, a control circuit 50, a current command circuit 60, and a lighting signal receiving circuit 70.

The power supply 2 supplies, for example, direct current (DC) voltage obtained through rectification and smoothing of commercial alternating current (AC) by a boost chopper circuit to the light-emitting element lighting device 1.

The light-emitting element 3 is a light-emitting element such as an LED, and is, for example, an organic EL light-emitting element. An organic EL light-emitting element, for example, has a structure in which a lower transparent electrode, a light-emitting layer, and an upper electrode are stacked above a substrate. The light-emitting layer includes a hole injection layer, a hole transport layer, an organic light-emitting layer, an electron injection layer, and so on. In the case where the aforementioned structure is, for example, a bottom emission structure, when voltage is applied between the lower transparent electrode and the upper electrode, holes and electrons are injected into the organic light-emitting layer and recombined therein, thereby generating an excited state that can emit light. Then, the light is emitted to the substrate side via the lower transparent electrode. Furthermore, the part of the light emitted from the light-emitting layer that is directed upward is reflected off the upper electrode and emitted to the substrate side via the lower transparent electrode.

When conductive foreign matter is present in the light-emitting layer between both electrodes of the organic EL light-emitting element having the above-described configuration, both electrodes are short-circuited via the foreign matter, and thus the current that should flow to the light-emitting layer is concentrated in the conductive foreign matter. This causes luminance deterioration or non-light emission of the organic EL light-emitting element.

Next, the respective structural components of the light-emitting element lighting device 1 will be described.

The control power supply circuit 10 supplies the power supply voltage of the control circuit 50.

The step-down chopper circuit 20 converts the power supplied from the power supply 2 into the DC power required by the light-emitting element 3, according to a control signal from the control circuit 50. The step-down chopper circuit 20 serves as a current generation unit which outputs current flowing in the light-emitting element 3.

The current detection circuit 30 detects the current flowing in the light-emitting element 3.

The voltage detection circuit 40 serves as a voltage detecting unit which detects the potential difference between the positive electrode and the negative electrode (hereinafter referred to as “both-end voltage”) of the light-emitting element 3.

The current command circuit 60 determines the mode of the current to be supplied to the light-emitting element 3, based on the both-end voltage of the light-emitting element 3 detected by the voltage detection circuit 40 and a lighting signal S outputted from the lighting signal receiving circuit 70. Specifically, the current command circuit 60 serves as a mode selecting unit which selects (i) a light-emitting mode for causing a light-emission current, which is larger than a rated current, to flow or (ii) a detecting mode for causing an abnormality detection current, which is smaller than the rated current, for detecting an abnormality in the light-emitting element 3, to flow. Here, the rated current is a constant current in the case where the light-emitting element 3 is turned ON continuously (emits light continuously at a rated luminance) as a light source of an illuminating apparatus.

The control circuit 50 generates a control signal based on the current value detected by the current detection circuit 30 and the mode selection signal from the current command circuit 60, and outputs the control signal to the step-down chopper circuit 20. Specifically, the control circuit 50 serves as a current control unit which causes the step-down chopper circuit 20 to stop the output of current to the light-emitting element 3, in the case where the both-end voltage of the light-emitting element 3 detected by the voltage detection circuit 40 in the detection mode is lower than or equal to the abnormality detection threshold voltage which is set lower than the rated voltage at the time when the light-emitting element 3 is turned ON.

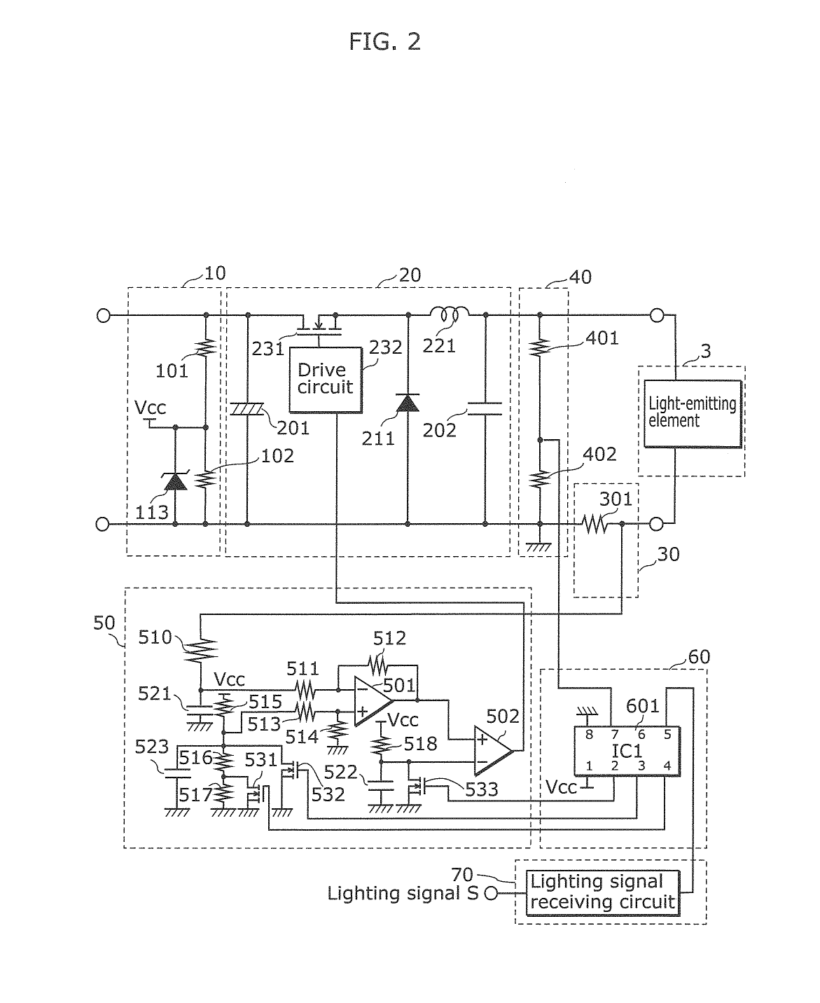

FIG. 2 is a diagram illustrating an example of a circuit configuration of a light-emitting element lighting system according to Embodiment 1.

In the control power supply circuit 10, a resistive element 101 and a resistive element 102 are connected in series between a positive electrode terminal and a negative electrode terminal. Furthermore, a Zener diode 113 is connected in parallel with the resistive element 102. With this circuit configuration, the voltage applied between the positive electrode terminal and the negative electrode terminal is divided by the resistive element 101 and the resistive element 102 to provide a power supply voltage Vcc of the control circuit 50. Furthermore, with the Zener diode 113, it is possible to prevent the power supply voltage Vcc from exceeding a predetermined voltage.

The step-down chopper circuit 20 includes an electrolytic capacitor 201, a switching element 231, a regeneration diode 211, an inductor 221, and a capacitor 202. DC voltage supplied from the power supply 2 is applied to the capacitor 201 which functions as a DC power supply. It should be noted that the power supply 2 may be a battery, a DC power supply, or the like. In the step-down chopper circuit 20, the switching element 231 is switched on and off at a high frequency to convert the DC power accumulated in the electrolytic capacitor 201 into the power required for the light-emitting element 3. The DC voltage of the electrolytic capacitor 201, that is, the DC voltage of the power supply 2 is, for example, 24 V, which is maintained at a constant voltage. This is the both-end voltage required to keep the light-emitting element 3 (organic EL light-emitting element) turned ON. It should be noted that, in the case of an organic EL light-emitting element which requires a both-end voltage of about 5 V to 10 V for light-emitting operation, the aforementioned DC voltage may be approximately 12 V. Furthermore, in the case where 10 organic EL elements each requiring a both-end voltage of about 5 V to 10 V for light-emitting operation are connected in series, a voltage of approximately 50 V to 100 V is required for the DC voltage.

The current command circuit 60 determines the value of the current which flows to the light-emitting element 3 as well as the duty ratio of the current which flows to the light-emitting element 3. A general-purpose microcomputer 601 is, for example, a flash memory-equipped 8-bit microcomputer having an analog-to-digital (A/D) conversion function. The general-purpose microcomputer 601 detects the both-end voltage of the light-emitting element 3 by monitoring (no. 7 pin) the voltage division point divided by a resistive element 401 and a resistive element 402, and judges whether the current flowing in the light-emitting element 3 is changed or not according to the detection result. In addition, the general-purpose microcomputer 601 performs turn-ON judgment and load abnormality detection. As such, the no. 7 pin is set as the A/D conversion input and reads the value of the both-end voltage of the light-emitting element 3 which corresponds to the both-end voltage of the capacitor 202. Furthermore, no. 2, no. 3, and no. 4 pins are set to binary outputs. A no. 1 pin is a power supply terminal and a no. 8 pin is a ground terminal.

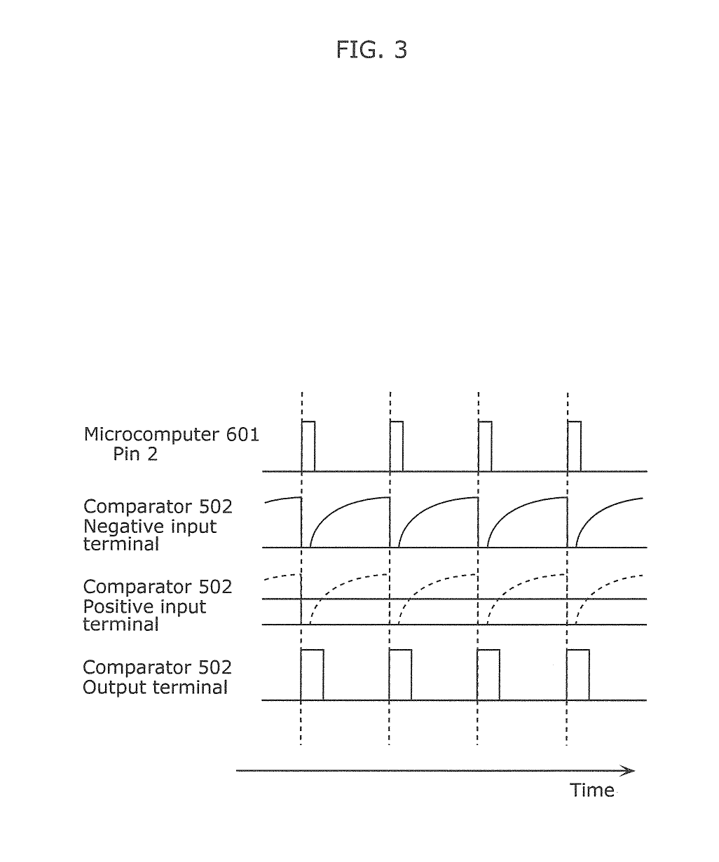

The control circuit 50 controls the switching element 231 of the step-down chopper circuit 20 to supply the desired power to the light-emitting element 3. The control circuit 50 detects the current value of the light-emitting element 3 using a current detection resistor 301, and adjusts the current value using an error amplifier 501. Specifically, by comparing the output voltage of the error amplifier 501 and a triangular wave signal of a negative terminal of a comparator 502, the control circuit 50 controls the ON-OFF operation of the switching element 231 of the step-down chopper circuit 20 to adjust the power supplied to the light-emitting element 3. The operation for generating a drive signal for the switching element 231 performed by the comparator 502 will be described below using FIG. 3.

As described above, the current command circuit 60 serves as a mode selection unit which selects a light-emission mode or a detection mode, and, together with the control circuit 50, constitutes a current control unit which controls the output of current to the light-emitting element 3 using the both-end voltage of the light-emitting element 3.

FIG. 3 is a timing chart for describing the operation of the control circuit according to Embodiment 1. The timing chart illustrated in the figure shows, from the top, the output voltage of the no. 2 pin of the general-purpose microcomputer 601, the voltage of a capacitor 522 which is applied to a negative input terminal of the comparator 502, the reference voltage applied to a positive input terminal of the comparator 502 (broken lines indicate the voltage of the capacitor 522), and the output terminal voltage of the comparator 502. It should be noted that the comparator 502 and the error amplifier 501 can be inexpensively configured using an integrated circuit provided with two operational amplifiers in a single package, and the control power supply thereof is supplied from the power supply voltage Vcc.

When the no. 2 pin of the general-purpose microcomputer 601 is at an H (high) level, a switching element 533 is turned ON, the capacitor 522 is short-circuited, and the charge accumulated therein is discharged. On the other hand, when the no. 2 pin of the general-purpose microcomputer 601 is at an L (low) level, the switching element 533 is turned OFF, the capacitor 522 is charged via a resistive element 518, and thus the voltage of the capacitor 522 rises. The voltage of the capacitor 522 is applied to the negative input terminal of the comparator 502. The output voltage of the error amplifier 501 is applied, as a reference voltage, to the positive input terminal of the comparator 502. In a period in which the voltage of the capacitor 522 is lower than the reference voltage, the output of the comparator 502 is at the H level. Therefore, the switching element 231 is switched ON and OFF at a frequency of the signal outputted from the no. 2 pin of the general-purpose microcomputer 601, and a pulse width of the signal increases as the output voltage of the error amplifier 501 rises. Therefore, by changing the reference voltage of the positive input terminal of the error amplifier 501, it is possible to adjust the current value of the light-emitting element 3.

Factors for changing the reference voltage inputted to the positive input terminal of the error amplifier 501 will be described below. The switching element 531 turns ON and OFF at a frequency of the output signal from the no. 4 pin of the general-purpose microcomputer 601. The voltage value of the capacitor 523 can be adjusted by changing a ratio of the ON time period of the switching element 531 (in charging: path from Vcc to resistive element 515 to capacitor 523; in discharge: path from capacitor 523 to resistive element 516 to switching element 531). With this, it becomes possible to change the reference voltage of the positive input terminal of the error amplifier 501 to adjust the current of the light-emitting element 3.

Furthermore, in the case of intermittently causing DC current to flow to the light-emitting element 3 (referred to as PWM control), the output of the no. 3 pin of the general-purpose microcomputer 601 is switched ON/OFF at any frequencies, and the effective value of the light-emitting element current is controlled by changing a ratio of the ON time period of the output. The no. 3 pin of the general-purpose microcomputer 601 is connected to a gate of the switching element 532.

The lighting signal receiving circuit 70 receives a lighting signal S from the outside, and adjusts a level of the lighting signal S to input it to the general-purpose microcomputer 601. Then, the lighting signal receiving circuit 70 outputs the signal to the no. 5 pin of the general-purpose microcomputer 601. The lighting signal S, which is a PWM signal of 1 kHz, is classified in a turning-ON mode, a turning-OFF mode, and a dimming mode according to a high voltage (Vcc) and a low voltage (0 V). Furthermore, when the general-purpose microcomputer 601 has an A/D conversion function, by performing D/A conversion of the lighting signal S to input the result to the general-purpose microcomputer 601, a turning-ON mode, a turning-OFF mode, and a dimming mode can be determined according to the analog value of the general-purpose microcomputer 601.

(Lighting Operation)

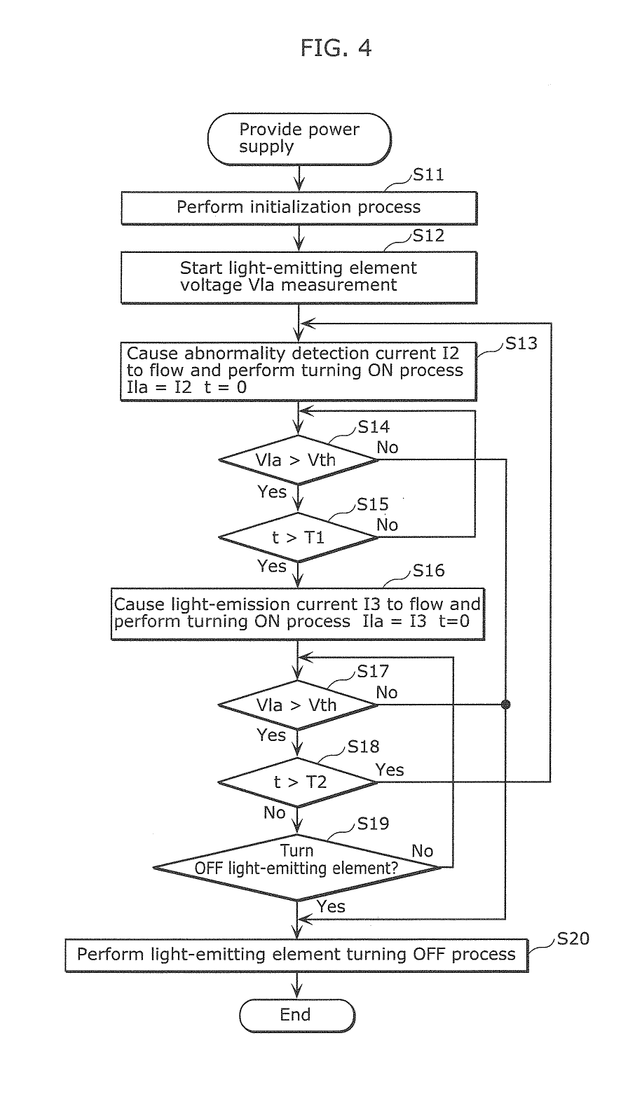

Next, the lighting operation of the light-emitting element lighting device according to this embodiment will be described using FIG. 4.

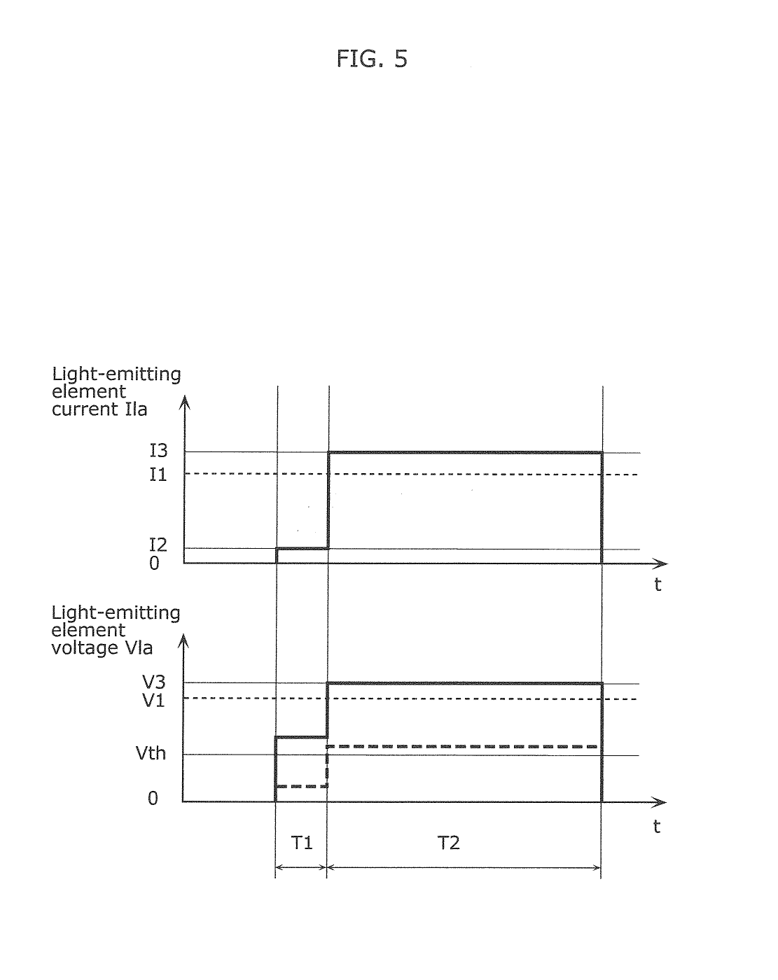

FIG. 4 is an operation flowchart for describing a light-emitting element lighting method according to Embodiment 1. Furthermore, FIG. 5 is a timing chart for light-emission current and abnormality detection current according to Embodiment 1.

First, when the power supply of the light-emitting element lighting device is provided, the light-emitting element lighting device 1 executes an initialization process (S11).

Next, the voltage detection circuit 40 starts measurement of a both-end voltage Vla of the light-emitting element 3 (S12). The both-end voltage is obtained by measuring a voltage at the voltage division point divided by the resistive element 401 and the resistive element 402. Step S13 is a voltage detecting step for detecting the both-end voltage of the light-emitting element 3.

Next, the control circuit 50, upon receiving an instruction from the current command circuit 60, causes an abnormality detection current I2 to flow to the light-emitting element 3 (S13). Stated differently, the current command circuit 60 selects the detection mode during a setting period T1. Here, the abnormality detection current I2 is a lighting current which is lower than the rated current. Furthermore, the abnormality detection current I2 flows to the light-emitting element 3 during the period T1. Step S13 is a mode selecting step for selecting the detection mode for causing the abnormality detection current I2 to flow. Here, the abnormality detection current I2 is a current that is smaller than a rated current I1, for detecting an abnormality in the light-emitting element 3.

Here, a comparison is performed as to whether or not the both-end voltage Vla is higher than an abnormality detection threshold voltage Vth (S14). The abnormality detection threshold voltage Vth is a threshold voltage which is set to a value smaller than the smallest value of a lighting start voltage V0, for judging an abnormality in the light-emitting element 3. If the both-end voltage Vla is higher than the abnormality detection threshold voltage Vth (Yes in step S14; solid line in FIG. 5), the operation proceeds to step S15. If the both-end voltage Vla is lower than or equal to the abnormality detection threshold voltage Vth (No in step S14; broken line in FIG. 5), the light-emitting element 3 is turned OFF (S20). Step S14 and step S20 are current controlling steps for stopping the output of current to the light-emitting element 3 in the case where the both-end voltage is lower than or equal to the abnormality detection threshold voltage Vth in the detection mode.

Next, in step S15, the voltage detection circuit 40 continues measuring the both-end voltage Vla while the time in which the abnormality detection current I2 flows is less than or equal to the setting period T1. On the other hand, when the time in which the abnormality detection current I2 flows becomes longer than the setting period T1 (Yes in S15), the control circuit 50 and the step-down chopper circuit 20 cause a light-emission current I3 to flow to the light-emitting element 3 upon receiving an instruction from the current command circuit 60 (S16). Step S16 is a mode selecting step for selecting a light-emission mode for causing a light-emission current, which is larger than the rated current, for turning ON the light-emitting element 3 to flow.

It should be noted that the current command circuit 60 and the control circuit 50 set the light-emission current I3 to achieve a light-emission luminance obtained by causing the rated current I1 to flow continuously for a predetermined lighting period. In other words, the current command circuit 60 and the control circuit 50 set the light-emission current I3 so that an average current of the light-emission current I3 and the abnormality detection current I2 flowing for the predetermined lighting period is equal to the rated current.

Here, a comparison is performed as to whether or not the both-end voltage Vla is higher than the abnormality detection threshold voltage Vth (S17). If the both-end voltage Vla is higher than the abnormality detection threshold voltage Vth (Yes in S17), the operation proceeds to step S18. If the both-end voltage Vla is lower than or equal to the abnormality detection threshold voltage Vth (No in S17), the light-emitting element 3 is turned OFF (S20).

Next, in step S18, the voltage detection circuit 40 continues measuring the both-end voltage Vla while the time in which the light-emission current I3 flows is less than or equal to a setting period T2. On the other hand, when the time in which the light-emission current I3 flows becomes longer than the setting period T2 (Yes in S18), the operation returns to step S13. On the other hand, when the time in which the light-emission current I3 flows is shorter than or equal to the setting period T2 (No in S18), the operation proceeds to step S19.

Next, in step S19, the turn OFF state of the light-emitting element 3 is judged (i.e., whether or not a turn OFF signal is received), and the operation returns to step S17 when a turn OFF signal is not received. When a turn OFF signal is received (Yes in S19), the light-emitting element 3 is turned OFF (S20).

According to the light-emitting element lighting device 1 and the light-emitting element lighting method in accordance with this embodiment, a short-circuit abnormality is determined by judging whether or not the voltage of the light-emitting element, which is detected when the abnormality detection current I2 lower than the rated current I1 flows, is lower than or equal to the abnormality detection threshold voltage Vth lower than the rated voltage V1. Therefore, compared to the case where short-circuit abnormality is determined by using a voltage detected when the rated current I1 flows, it is possible to clearly distinguish the voltage of a short-circuited abnormal light-emitting element from the voltage of a normal light-emitting element, and thus a short-circuit abnormality can be detected with high accuracy. Furthermore, it is ensured that the output of current to a short-circuited abnormal element is stopped. In addition, since the light-emission current I3 is set so that the average current of the light-emission current I3 and the abnormality detection current I2 flowing for the predetermined lighting period is equal to the rated current, a stable turn ON state can be ensured without reducing the amount of light-emission, even when the period for detecting a short-circuit abnormality is inserted.

(Detection Principle)

Here, the advantageous effects produced by the above-described light-emitting element lighting device and light-emitting element lighting method according to this embodiment compared to the conventional apparatus and method will be described.

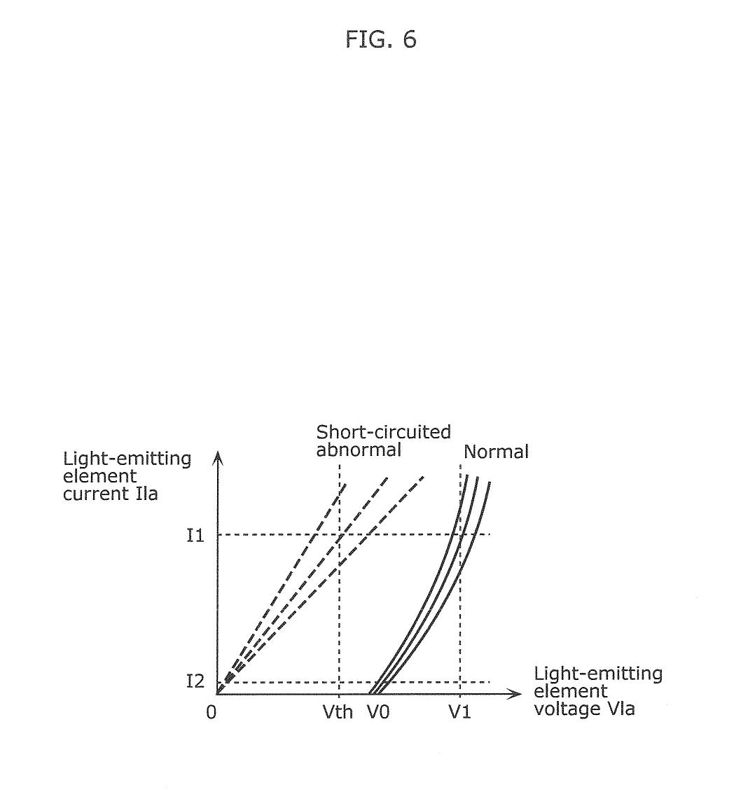

FIG. 6 is a graph illustrating voltage-current characteristics of normal and short-circuited abnormal light-emitting elements. In the figure, the solid lines (3 lines) denote the voltage-current characteristics of a normal light-emitting element. The voltage when the light-emitting element starts emitting light is a lighting start voltage V0. Furthermore, the rated voltage when the rated current I1 flows is V1. Here, the rated current is defined as a constant current for turning ON the light-emitting element 3 continuously (emits light continuously at a rated luminance) as a light source of an illuminating apparatus.

On the other hand, the broken lines (3 lines) denote the voltage-current characteristics of a short-circuited abnormal light-emitting element. When the current is OA, the voltage is 0 V, and approximately linear voltage-current characteristics (resistance characteristics) are shown.

As illustrated in FIG. 6, the voltage-current characteristics of a short-circuited abnormal light-emitting element have significant variation in resistance value (slope of current with respect to voltage) due to such short-circuited state. Here, in the case where the rated current I1 is caused to flow to the light-emitting element to determine an abnormal light-emitting element according to the voltage value of the light-emitting element at such time, the voltage value of a short-circuited abnormal light-emitting element is varied due to the variation in resistance value and may approach the rated voltage V1 which is the both-end voltage of a normal light-emitting element, and thus there is a possibility of misjudging the abnormal light-emitting element as being normal.

In contrast, as the detection current which flows to the light-emitting element is made smaller compared to the rated current I1, the voltage value of the normal light-emitting element approaches the lighting start voltage V0, whereas the voltage value of the abnormal light-emitting element approaches 0 while the variation of the voltage value is being reduced. In other words, as the abnormality detection current I2 is set smaller than the rated current I1, the difference between the voltage of the normal light-emitting element and the voltage of the abnormal light-emitting element is enlarged, thereby ensuring the setting margin for the abnormality detection threshold voltage Vth and enabling more accurate judgment.

From the above perspective, it is preferable that the abnormality detection threshold voltage Vth be set lower compared to the lighting start voltage V0. Furthermore, although it is sufficient that the abnormality detection current I2 is set to be smaller than the rated current I1, in order to enhance detection accuracy, it is preferable that the abnormality detection current I2 be set to less than or equal to 10% to 1% of the rated current I1.

The respective setting parameters in this embodiment will be illustrated by example below. For example, the rated voltage V1 of an organic EL light-emitting element is 7.5 V, and the rated current I1 is 0.3 A. At this time, the light-emitting area is 64 cm², the lighting start voltage V0 is 4 V, the abnormality detection threshold voltage Vth is 3 V, and the abnormality detection current I2 is 10 mA. Here, assuming that a short-circuited abnormal light-emitting element has a voltage of 5 V when the rated current I1 flows thereto, the light-emitting voltage becomes higher than or equal to the abnormality detection threshold voltage Vth (as a resistance value: 16.7Ω (=5V/0.3 A)). This means that it is difficult to detect a short-circuit abnormality using the rated current I1. In contrast, the light-emitting element has a voltage of 0.17 V (=16.7 Ω×10 mA) when the abnormality detection current I2 flows thereto. This is lower than the abnormality detection threshold voltage Vth, and thus a short-circuit abnormality can be detected.

Here, an example of the light-emitting element current and voltage illustrated in FIG. 5 will be described.

When the light-emission of the light-emitting element 3 is started, the abnormality detection current I2 flows during the period T1 in the detection mode, and, subsequently, the light-emission current I3 flows during the period T2 in the light-emission mode. Then, the period T1 and the period T2 are repeated. In other words, the current command circuit 60 selects the light-emission mode and the detection mode alternately. With this, non light-emitting time is eliminated and the short-circuited abnormal state of the light-emitting element can be detected. At this time, the light-emission current I3 and the abnormality detection current I2 are set so that the average current is equal to the rated current I1, as described above. Therefore, Equation 1 below is satisfied.

I1=(T1×I2+T2×I3)/(T1+T2) (Equation 1)

To improve the detection effect, a ratio of the light-emission current I3 to the abnormality detection current I2 is set to be less than or equal to 9:1 or 99:1.

For example, by setting I3:I2=99:1 and T1:T2=1:99, Equation 1 provides I3=1.01×I1, I2=0.01×I1, and thus it is sufficient that the light-emission current I3 may increase by approximately 1% beyond the rated current I1.

It should be noted that the period T1 for the detection mode, which is set according to the time available for detection for the circuit system, ranges from approximately several microseconds to several milliseconds.

### Embodiment 2

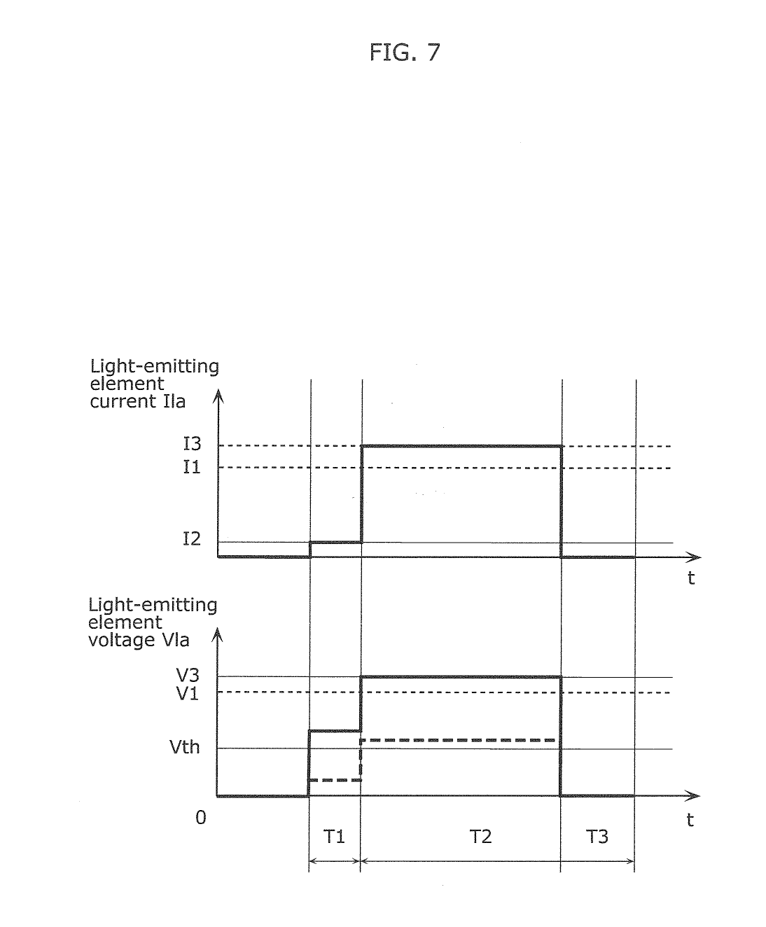

Hereinafter, a light-emitting element lighting device and a lighting method thereof according to Embodiment 2 will be described using FIG. 7. The light-emitting element lighting device according to this embodiment has the same configuration as the light-emitting element lighting device according to Embodiment 1, and is different only in the output timing of the light-emission current I3 and the abnormality detection current I2 instructed by the current command circuit 60. Hereinafter, points which are substantially the same as in Embodiment 1 is omitted, and description is carried out focusing on the points of difference.

FIG. 7 is a timing chart for light-emission current and abnormality detection current according to Embodiment 2. The difference from the output timing of the light-emission current and abnormality detection current according to Embodiment 1 lies in the setting of a period T3 in which current does not flow to the light-emitting element 3, after the end of period T2 in which the light-emission current I3 flows.

As illustrated in FIG. 7, according to the output timing of the light-emission current and abnormality detection current according to this embodiment, the average current is adjusted based on a ratio of (i) a total of period T1 and period T2 to (ii) period T3 to control the luminance, i.e., perform dimming. Here, period T1 is a period in which the abnormality detection current I2 flows, period T2 is a period in which the light-emission current I3 flows, and period T3 is a period in which no current flows. Here, the dimming rate is expressed through Equation 2 below.

Dimming rate=(T1+T2)/(T1+T2+T3) (Equation 2)

Furthermore, the repetition frequency f (=1/cycle T=1/(T1+T2+T3)) in the aforementioned period is set to higher than or equal to 200 Hz so that flickering is not experienced by a user.

Furthermore, by controlling period T1, period T2, and period T3 in this order, the light-emission current is raised from a small value (I2) to the vicinity of the rated current (I3), thereby reducing current-based stress, temperature stress, or the like of the light-emitting element 3.

In this embodiment, when a dimming signal is inputted from an outside source, the current command circuit 60 determines, based on the dimming signal, the ratio of the period in which current flows to the light-emitting element 3 and the period in which current does not flow to the light-emitting element 3. With this, a short-circuited abnormal state of the light-emitting element 3 can be detected even during dimming, which makes it possible to stop supplying current to the short-circuited abnormal light-emitting element that has been determined above.

Moreover, the period in which current flows to the light-emitting element 3 is configured to have, in this sequence, period T1 in which the abnormality detection current I2 flows and period T2 in which the light-emission current I3 does not flow. With this, stress on the light-emitting element 3 can be reduced.

### Embodiment 3

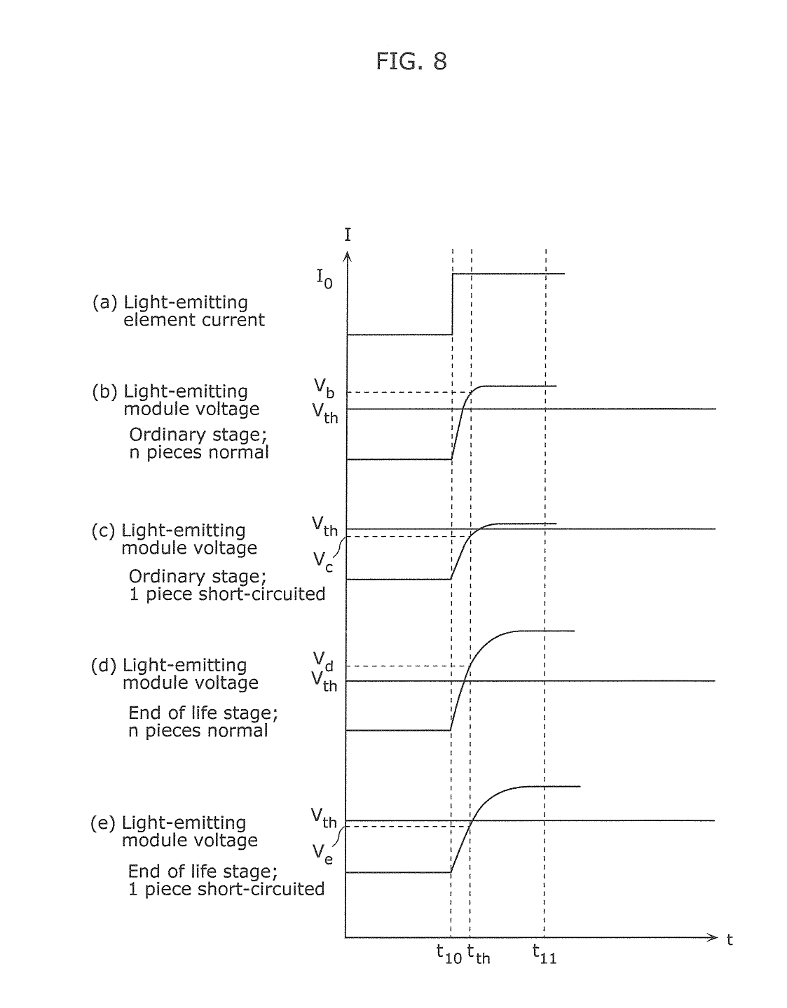

Hereinafter, a light-emitting element lighting device and a lighting method thereof according to Embodiment 3 will be described using FIG. 8 to FIG. 11. The light-emitting element lighting device according to this embodiment has the same configuration as the light-emitting element lighting device according to Embodiment 1, and is different in the timing at which light-emitting element voltage detection is performed. Hereinafter, points which are substantially the same as in Embodiment 1 is omitted, and description is carried out focusing on the points of difference.

FIG. 8 is a timing chart for light-emission current and light-emission voltage according to Embodiment 3. The timing for detecting the both-end voltage of the light-emitting element according to this embodiment is different from the timing for detecting the both-end voltage of the light-emitting element according to Embodiment 1 in that light-emission voltage is detected at a predetermined detection time tₜₕ within the abnormality detection current period (t₁₀ to t₁₁), where t₁₀ is the time at which the light-emission current begins to flow and t₁₁ is the time at which the light-emission voltage becomes steady.

In the case where n pieces of light-emitting elements 3, the number of which is already known, are connected in series, it can be considered that capacitance components of the light-emitting elements 3 are connectively arranged in series. Here, the n pieces of light-emitting elements 3 that are connected in series are defined as a light-emitting module. In this case, during the rise of the light-emission current, the rise of the both-end voltage of the light-emitting module is delayed due to the capacitance component of the light-emitting module, as illustrated in (a) in FIG. 8.

For example, when one out of the n pieces of light-emitting elements 3 connected in series is short-circuited, the capacitance component of the short-circuited light-emitting element 3 changes into a resistance component. As such, it can be considered that one of the capacitance components connectively arranged in series has changed into a resistance component, which increases the time constant. With this, the both-end voltage of the light-emitting module is as represented by the waveform illustrated in (c) in FIG. 8. Specifically, due to the increase in time constant, when the rise time of the both-end voltage is employed as detection time tₜₕ, due to the increase in time constant, both-end voltage Vc in which 1 piece is short circuited is lower than both-end voltage Vb in which all the n pieces are normal.

Furthermore, the characteristics of the light-emitting module vary together with operating life. As such, with regard to the detection of change in the both-end voltage due to the short-circuiting of a light-emitting element 3, the operating life of the light-emitting module needs to be taken into consideration.

For example, in the case where the n pieces of light-emitting elements 3 connected in series are at the end of life stage, the both-end voltage indicates the waveform illustrated in (d) in FIG. 8, and has a steady value higher than that of the both end voltage illustrated in (b) in FIG. 8, in which the n pieces of light-emitting elements 3 are not at the end of life stage. This also increases the time constant. As such, the both-end voltage Vd at the detection time tₜₕ, in which the n pieces of the light-emitting elements 3 are all normal but are at the end of life varies a little compared to the both-end voltage Vb.

In contrast, the both-end voltage in which the n pieces of light-emitting elements 3 connected in series are all at the end of life stage and additionally 1 piece is short-circuited, indicates the waveform illustrated in (e) in FIG. 8. Specifically, due to the increase in time constant, at the detection time tₜₕ, the both-end voltage Ve is lower than the both-end voltage Vd in which all the n pieces are normal.

However, following the above-described characteristics of the light-emitting module, the both-end voltage is detected at the detection time tₜₕ within the abnormality detection current period (t₁₀ to t₁₁) and compared whether or not it is higher than the abnormality detection threshold voltage Vₜₕ. With this, abnormality of a light-emitting module including plural light-emitting elements 3 which are connected in series can be accurately judged.

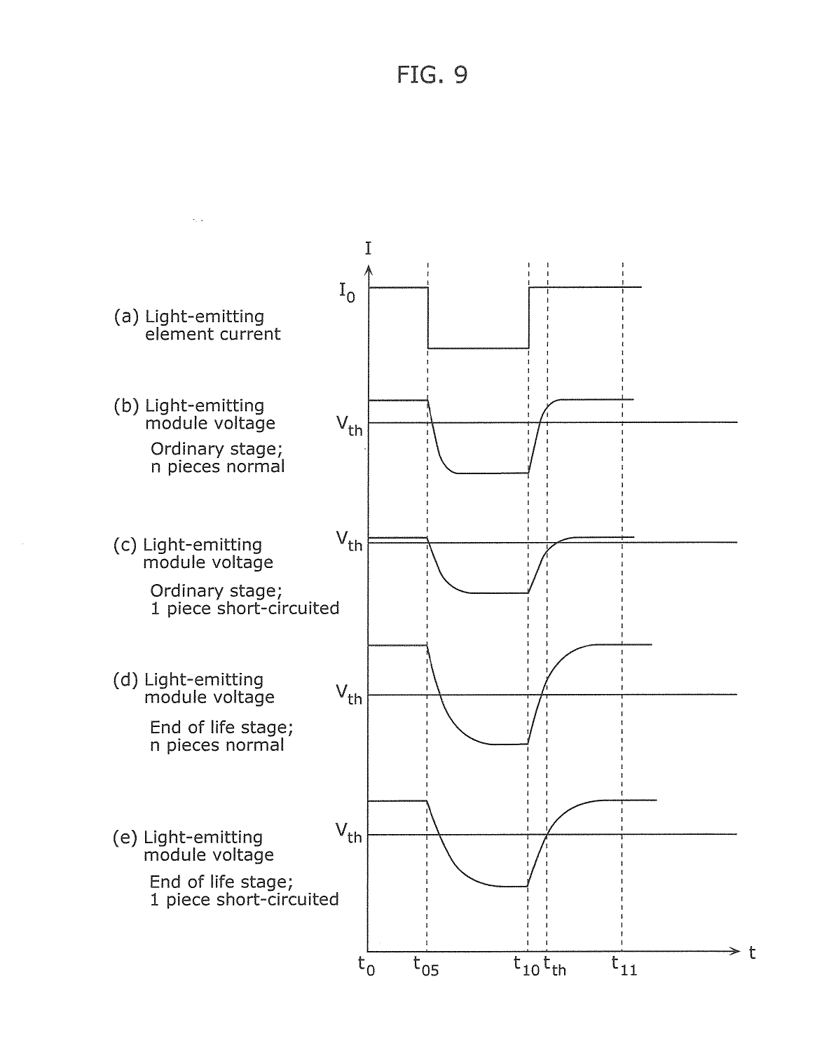

FIG. 9 is a timing chart for light-emission current and light-emission voltage when an abnormality detection method according to Embodiment 3 is used while a light-emitting element is turned ON. Before and after a time t₀, a light-emission current I₀ flows in the light-emitting module. Here, in order to detect an abnormality of the light-emitting module within the abnormality detection voltage period (t₁₀ to t₁₁), the light-emission current I0 is stopped in the period from time t₀₅ to time t₁₀. Then, at the time t₁₀, the light-emission current I₀ rises. With this, abnormality in the light-emitting module composed of the known number of pieces of light-emitting elements can be judged accurately.

In other words, according to the light-emitting element lighting device in accordance with this embodiment, the detection mode is set in a transient period (t₁₀ to t₁₁) in which the current, flowing in either a single light-emitting element 3 or plural light-emitting elements 3 connected in series, transitions from a current smaller than a rated current to the light-emission current larger than the rated current. The current command circuit 60 stops the output of current to the light-emitting module when the both-end voltage of the light-emitting module detected at the detection time tₜₕ within the transient period is lower than or equal to the abnormality detection threshold voltage Vₜₕ, which is set lower than a sum light-emission voltage which is the sum of the light-emission voltages at the time when the light-emitting elements 3 included in the light-emitting module are turned ON.

It should be noted that the detection time tₜₕ for detecting the both-end voltage of the light-emitting module may be set at an ON time (at a time when the input voltage Vin is in the ON state).

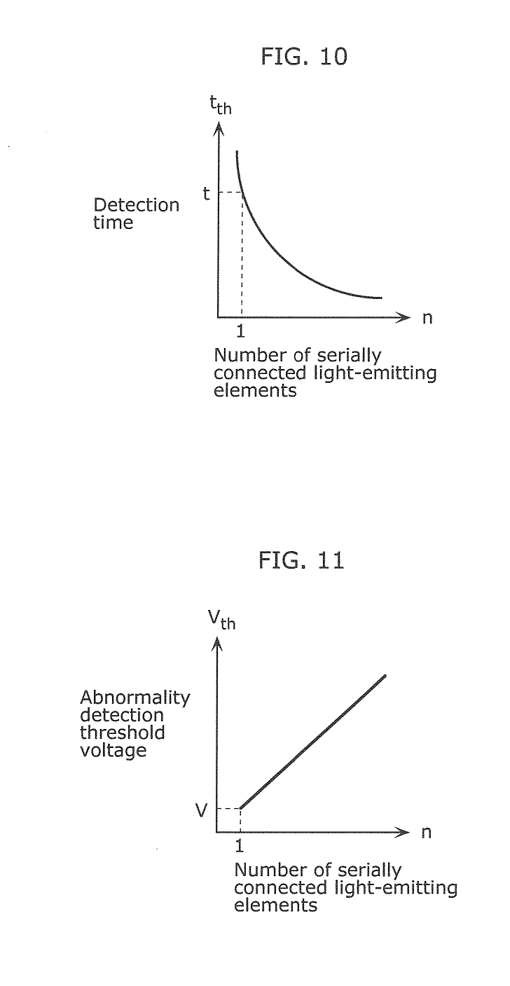

FIG. 10 is a graph illustrating a relationship between the number of serially connected light-emitting elements in a light-emitting module and detection time, and FIG. 11 is a graph illustrating a relationship between the number of serially connected light-emitting elements in a light-emitting module and abnormality detection threshold voltage. As illustrated in FIG. 10, since the light-emission voltage becomes higher as the number of serially connected light-emitting elements in the light-emitting module is increased, the detection time tₜₕ (i.e., the period from time t₁₀ to tₜₕ) for accurately measuring the both-end voltage of the light-emitting module can be set to be short. Furthermore, as illustrated in FIG. 11, since the light-emission voltage becomes higher as the number of serially connected light-emitting elements in the light-emitting module is increased, the abnormality detection threshold voltage Vₜₕ is set high to ensure accuracy in detecting the abnormality of a single light-emitting element 3.

According to the light-emitting module abnormality detection method in accordance with this embodiment, in detecting an abnormality in a light-emitting module having a large capacitance component, the both-end voltage of the light-emitting module is measured in the transient state in which current transitions from a current smaller than a rated current to a current larger than the rated current. Therefore, abnormality of a light-emitting module including light-emitting elements which are connected in series can be accurately detected. Furthermore, compared to the case of causing an abnormality detection current which is smaller than the rated current to flow and measuring the both-end voltage of the light-emitting module in a state in which the both-end voltage is in a steady state, the abnormality of the light-emitting module can be detected rapidly.

### Embodiment 4

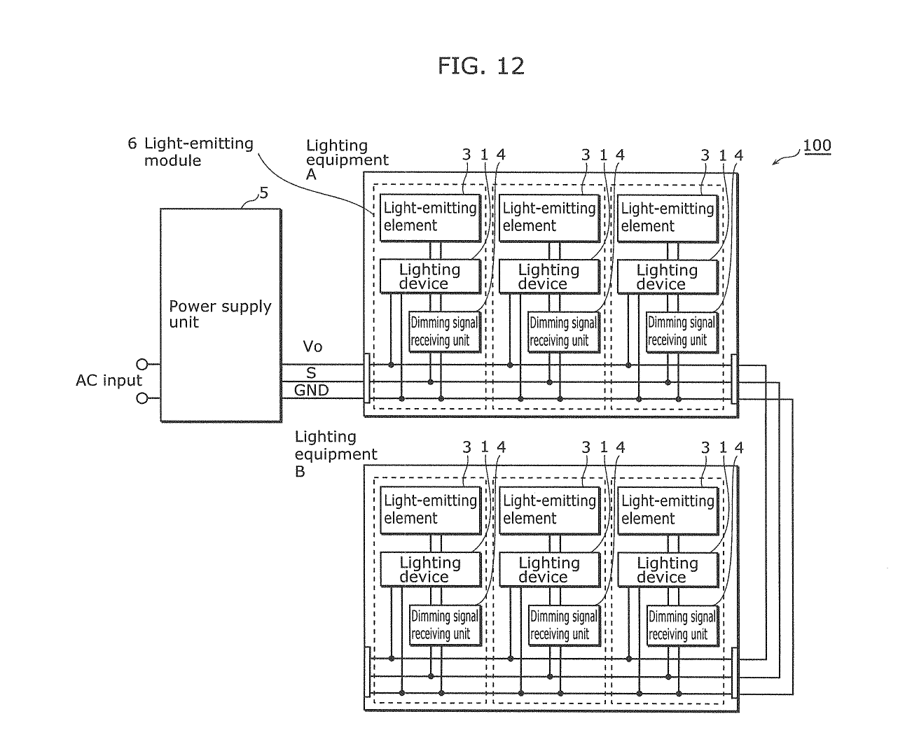

Hereinafter, a light-emitting module according to Embodiment 4 will be described using FIG. 12.

FIG. 12 is a block configuration diagram of an illuminating system including a light-emitting module according to Embodiment 4. The illuminating system illustrated in the figure includes a power supply unit 5, lighting equipment A, and lighting equipment B. The lighting equipment A and the lighting equipment B each include plural light-emitting modules 6. Furthermore, each light-emitting module 6 includes the light-emitting element 3, the light-emitting element lighting device 1, and a dimming signal receiving unit 4.

The light-emitting element 3 is an organic EL light-emitting element in which input current and light output are in an approximately proportionate relationship, and is composed of a single or plural light-emitting elements.

The light-emitting element lighting device 1 is a light-emitting element lighting device according to one of Embodiments 1 and 2, runs on a constant current control system, and includes, for example, a step-down chopper circuit. In addition, the light-emitting element lighting device 1 has a dimming function, and performs amplitude dimming, PWM dimming, or the like, upon receiving a signal from the dimming signal receiving unit 4.

The dimming signal receiving unit 4 converts a dimming signal from the power supply unit 5 into a command value and transmits the command value to the light-emitting element lighting device 1.

With the light-emitting module 6 according to this embodiment, it is possible to accurately detect the short-circuited abnormal state of the light-emitting element 3, and stop the current to the light-emitting element 3 that has been judged to be short-circuited.

It should be noted that the same advantageous effect can be obtained whether the number of light-emitting modules 6 included in the lighting equipment is more than or less than three.

### Embodiment 5

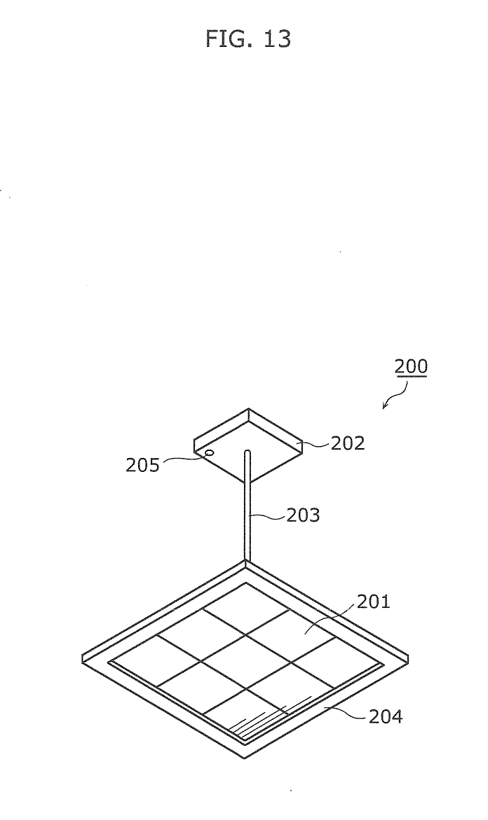

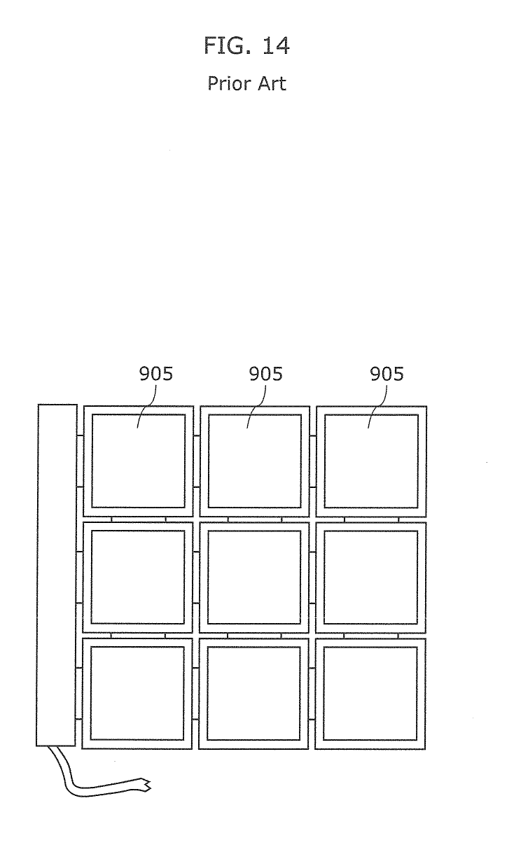

Hereinafter, an illuminating apparatus according to Embodiment 5 will be described using FIG. 13.

FIG. 13 is a perspective view of an external appearance of the illuminating apparatus according to Embodiment 5. An illuminating apparatus 700 illustrated in the figure includes light-emitting element lighting devices and light-emitting modules according to Embodiments 1 to 3, and specifically includes a light-emitting unit 701 including plural light-emitting modules, suspending equipment 702 for installing the light-emitting unit 701 to a ceiling, and a power supply cord 703 connecting the light-emitting unit 701 and the suspending equipment 702. The periphery of the light-emitting unit 701 is covered and protected by a lighting equipment case 704. The suspending equipment 702 includes on its surface a remote control receiving unit 705 for receiving a remote control signal transmitted from a remote control (not shown in the figure).

According to the illuminating apparatus 700 according to this embodiment, it is possible to accurately detect the short-circuited abnormal state of a light-emitting element 3, and stop the current to the light-emitting element 3 that has been judged to have a short-circuit abnormality.

It should be noted that although the illuminating apparatus 700 according to this embodiment is exemplified as being suspended from the ceiling, the same advantageous effect can be obtained even when it is installed on a wall.

Although light-emitting element lighting devices, light-emitting modules, illuminating apparatuses, and light-emitting element lighting methods according to the present invention are described thus far based on Embodiments 1 to 5, the present invention is not limited to these embodiments. Forms obtained through various modifications to the above embodiments as well as forms obtained by arbitrary combinations of constituent elements in different embodiment that may be conceived by a person of ordinary skill in the art, for as long as they do not depart from the essence of the present invention, are included in the scope of one or plural aspects of the present invention.

Furthermore, the circuit configuration illustrated in the foregoing circuit diagrams are examples, and the present invention is not limited by the foregoing circuit configurations. In other words, a circuit capable of realizing the characteristic functions of the present invention in the same manner as the foregoing circuit configurations is also included in the present invention. For example, a circuit in which an element such as a transistor, a resistive element, or a capacitive element is connected to a certain element in series or in parallel, within a scope that enables the same functions as the foregoing circuit configurations to be realized, is also included in the present invention. Stated differently, the connection between the elements in the foregoing embodiments include not only the case where terminals (nodes) of elements are directly connected, but also the case where the terminals (nodes) are connected via a different element, within a scope that enables the same functions to be realized.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A light-emitting element lighting device which turns ON a light-emitting element, the light-emitting element lighting device comprising:
a current generation unit configured to output a current that flows to the light-emitting element;
a mode selection unit configured to select between (i) a light-emission mode for causing a light-emission current, which is larger than a rated current, to flow and (ii) a detection mode for causing an abnormality detection current, which is smaller than the rated current, to flow for detecting an abnormality in the light-emitting element, the rated current being a constant current that is caused to flow to the light-emitting element when the light-emitting element is caused to emit light continuously;
a voltage detection unit configured to detect a both-end voltage of the light-emitting element; and
a current control unit configured to cause the current generation unit to stop outputting the current to the light-emitting element, when the both-end voltage detected by the voltage detection unit in the detection mode is lower than or equal to an abnormality detection threshold voltage which is set lower than the rated voltage at a time when the light-emitting element is turned ON.

2. The light-emitting element lighting device according to claim 1,
wherein an average current in a predetermined lighting period in which the light-emission current and the abnormality detection current flow is equal to the rated current.

3. The light-emitting element lighting device according to claim 1,
wherein the abnormality detection threshold voltage is set lower than or equal to a light emission start voltage at which the light-emitting element starts to emit light.

4. The light-emitting element lighting device according to claim 2,
wherein the mode selection unit is configured to select the light-emission mode and the detection mode alternately.

5. The light-emitting element lighting device according to claim 4,
wherein the mode selection unit is further configured to, when a dimming signal is inputted from an outside source, determine, based on the dimming signal, a ratio between a period in which a current flows to the light-emitting element and a period in which a current does not flow to the light-emitting element.

6. The light-emitting element lighting device according to claim 5,
wherein a period in which the abnormality detection current flows and a period in which the light-emission current flows are set in this sequence in the period in which a current flows to the light-emitting element.

7. The light-emitting element lighting device according to claim 1,
wherein the current control unit is configured to cause the current generation unit to stop outputting a current to a light-emitting module that includes the light-emitting element singularly or in a plurality connected in series, when, in the detection mode which is set in a transient period, a both-end voltage of the light-emitting module detected at a predetermined time in the transient period is lower than or equal to the abnormality detection threshold voltage that is set lower than a sum light-emission voltage which is a sum of light-emission voltages at a time when light-emitting elements included in the light-emitting module are turned ON, the transient period being a period in which a current which is smaller than the rated current transitions to the light-emission current which is larger than the rated current.

8. The light-emitting element lighting device according to claim 7,
wherein the mode selection unit is configured to select the detection mode at least once in a period in which the light-emitting module is continuously turned ON.

9. The light-emitting element lighting device according to claim 7,
wherein the mode selection unit is configured to select the detection period for a predetermined period, immediately after power supply is provided.

10. The light-emitting element lighting device according to claim 7,
wherein the current control unit is configured to shorten a period from a start time of the transient period up to the predetermined time, as the number of the light-emitting elements included in the light-emitting module is increased.

11. The light-emitting element lighting device according to claim 7,
wherein the current control unit is configured to set the abnormality detection threshold voltage higher as the number of the light-emitting elements included in the light-emitting module is increased.

12. A light-emitting module comprising:
a light-emitting element; and
the light-emitting element lighting device according to claim 1.

13. An illuminating apparatus comprising
a plurality of the light-emitting modules according to claim 12.

14. A lighting method for turning ON a light-emitting element, the lighting method comprising:
selecting between (i) a light-emission mode for causing a light-emission current, which is larger than a rated current, to flow and (ii) a detection mode for causing an abnormality detection current, which is smaller than the rated current, to flow for detecting an abnormality in the light-emitting element, the rated current being a constant current that is caused to flow to the light-emitting element when the light-emitting element is caused to emit light continuously;
detecting a both-end voltage of the light-emitting element; and
stopping output of current to the light-emitting element, when the both-end voltage detected by the voltage detection unit in the detection mode is lower than or equal to an abnormality detection threshold voltage which is set lower than the rated voltage at a time when the light-emitting element is turned ON.
